(19) United States
(12) Patent Application Publication
(10) Pub. No.: US 2015/0194066 A1
(43) Pub. Date: Jul. 9, 2015

(54) MEDICAL DEVICE TRAINING SYSTEMS AND METHODS OF USING

(71) Applicant: UNIVERSITY OF PITTSBURGH-OF THE COMMONWEALTH SYSTEM OF HIGHER EDUCATION, PITTSBURGH, PA (US)

(72) Inventors: Joseph T. Samosky, Pittsburgh, PA (US); Andrew Scott Thornburg, Austin, TX (US); Frank William Petraglia, III, Durham, NC (US); Tushar R. Karkhanis, Brooklyn, NY (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 14/410,693

(22) PCT Filed: Jul. 1, 2013
(86) PCT No.: PCT/US2013/048895

§ 371 Date: Dec. 23, 2014

Related U.S. Application Data
(60) Provisional application No. 61/666,435, filed on Jun. 29, 2012.

(51) Int. Cl. G09B 9/00

(52) U.S. Cl. CPC G09B 9/00

(57) ABSTRACT

A smart peripheral device for use in a medical training system. The medical training system having a processing device, software to emulate aspects of a medical device and a display in communication therewith. The processing device, software and display providing an interactive interface which emulates a portion of the medical device. The smart peripheral device includes a physical structure adapted to imitate a functional component of a medical device and at least one sensor adapted to measure an aspect of user performance, such as position, pressure or other physical variable.

### CROSS-REFERENCE TO RELATED APPLICATION

This application claims priority under 35 U.S.C. §119(e) from U.S. Provisional Application No. 61/666,435, entitled “Hybrid Physical-Virtual Medical Device Personal Trainers with Smart Peripherals”, which was filed on Jun. 29, 2012, the disclosure of which is incorporated herein by reference.

### FIELD OF THE INVENTION

The present invention is directed to medical training systems and methods and, more particularly, to systems and methods for medical training and learner performance assessment which simulate use of an actual medical device by utilizing virtual, screen-based simulations of one or more portions of an actual device in conjunction with realistic physical replications of other portions of the device. Both the virtual and physical portions may include sensors and displays not present in the actual device, thereby extending and enhancing the capabilities of the training system to promote learning and performance assessment.

### BACKGROUND OF THE INVENTION

Medical training requires learning how to operate devices as well as how to interact with patients. Errors made while operating medical devices cause significant injury and preventable deaths. Each year in the United States an estimated 44,000 to 98,000 patients die as a result of preventable medical error. The upper figure makes medical error the 6th leading cause of death in the U.S., with more annual mortality than deaths directly attributable to diabetes, motor vehicle accidents, breast cancer, influenza, or pneumonia according to data from the Centers for Disease Control. A recent study found that serious errors involving critically ill patients are common (150 errors per 1000 patient-days), with failure to carry out intended treatment correctly being the leading cause of these errors. Improved methods are needed to train and evaluate healthcare personnel in how to operate devices ranging from infusion pumps to EKG machines to defibrillators.

The concept of functionally emulative, interactive screen-based simulations of instrumentation has an extensive history (e.g., multiple publications and patents by National Instruments Corporation), and has been described numerous times in the medical domain for medical devices. For example, in healthcare simulation, high fidelity “manikins” (e.g., made by companies such as Laerdal, CAE Healthcare and Gaumard) frequently employ screen-based emulations of patient monitors. A screen-based virtual ventilator has been described by researchers at Washington State University and a virtual anesthesia machine has been developed at the University of Florida.

The Laerdal-developed American Heart Association ACLS e-learning program, “Heart Code ACLS”, has included since at least 2004 an emulator of the Philips HeartStart MRx biphasic defibrillator control panel. A charge button and a simulated ECG display are also implemented. The AHA/Laerdal virtual defibrillator is integrated into a timed scenario including a model of other aspects of treatment of a victim of cardiac arrest. Heart Code ACLS also includes virtual versions of a generic defibrillator and Philips HeartStart model FR2, HS1 and 4000 defibrillators. Screen-based medical device simulators similar to the Laerdal MRx have also been implemented in the thesis research of Cyle Sprick, “A Medical Simulator using Standardised Patients with Simulated Physiological Measurements”, Flinders University, 2010.

A screen-based virtual extracorporeal membrane oxygenation (ECMO) machine simulator has been developed by Dr. D. A. Pybus of MSE PL (Sydney, Australia), and, as early as 1997, in U.S. Pat. No. 6,024,539 Michael Blomquist described a virtual infusion pump that could be used for simulation-based training.

While such prior devices have generally been satisfactory for many training simulations, there is still room for improvement in training devices and methods associated with their use. In particular, screen-based simulations of medical devices, even when implemented on touch-screen enabled platforms, may provide limited tactile and proprioceptive interaction with important physically-manipulated components of the medical device, such as defibrillator paddles or pads, electrode placement for an ECG machine, or tubing installation in an infusion pump. The present invention partitions interface components of the original device between virtual and physical components of the training system to enhance hands-on interaction during training. The present invention also adds sensing, augmented information display and data recording capabilities to support objective assessment of learner performance and self-learning capabilities.

### SUMMARY OF THE INVENTION

Embodiments of the present invention improve upon known devices and methods in a variety of ways. Functionality and features that distinguish embodiments of the present invention from the above approaches include several major innovations, including the use of a combination of physical, sensor-enhanced hands-on device components (“smart peripherals”) with the virtual screen-based emulations, forming a hybrid physical-virtual simulator of the device; the addition of information display and feedback capabilities (not present in the original medical device) to the training system to enable self-learning via automated feedback and guidance; the quantitative, time-stamped recording of all interactions of a user with the hybrid device for performance assessment and to serve as the basis for learner-adaptive tutorial feedback; provision of wireless, vibrotactile signaling of device status or correct/incorrect procedure execution, and the provision of consequence display, showing the user the potential negative effects of incorrect device operation.

In one non-limiting embodiment, a smart peripheral device for use in a medical training system is provided. The medical training system includes a processing device, software to emulate aspects of a medical device and a display in communication therewith. The processing device, software and display provide an interactive interface which emulates a portion of a medical device. The smart peripheral device comprises: a physical structure adapted to imitate a functional component of a medical device and at least one sensor adapted to measure an aspect of the physical structure, the aspect being one or more of position with regard to an external body, pressure exerted on the external body, or other physical variable.

The functional component of the medical device which the physical structure is adapted to imitate may comprise a housing adapted to imitate a defibrillator paddle.

The at least one sensor may comprise a pressure sensor adapted to determine the pressure exerted by the housing on the external body.

The at least one sensor may comprise a sensing system adapted to detect the relative position of the physical structure of the peripheral device with respect to the external body.

The physical structure may comprise a housing; the sensing system may include a plurality of hall-effect sensors disposed in or on the housing and in communication with a processor disposed within the housing; the external body may comprises a simulated torso surface having a number of magnetic targets disposed at least one of therein or thereon; and the sensors may be positioned and adapted to detect the relative positioning of the housing with respect to at least one of the magnetic targets.

The physical structure may further includes a number of optical indicators disposed thereon.

The number of optical indicators may comprise a plurality of light emitting diodes. The plurality of light emitting diodes may be adapted to provide an indication to a user of the smart peripheral device of the relative positioning of a target on the external body with respect to the physical structure. The indication may comprise illuminating at least one light emitting diode of the plurality of light emitting diodes a first color as an indication the physical structure is not positioned on the target and illuminating at least two of the light emitting diodes a second color as an indication the physical structure is positioned on the target.

As another aspect of the invention, a medical training system is provided. The system comprises: a processing device; software to emulate aspects of a medical device; a display in communication with the processing device; and a smart peripheral device as described above wherein the at least one sensor of the smart peripheral device is in communication with the processing device.

The processing device may be adapted to automatically identify the smart peripheral device is connected to the processing device and the processing device may be adapted to then automatically execute software to simulate the medical device that corresponds to the peripheral.

The medical training system may further comprise a wireless vibrotactile signaling device that enables vibratory signals to be displayed corresponding to various states of the system, including the states wherein a user's performance has been sensed as either correctly or incorrectly executing a task.

The physical structure of the smart peripheral device may comprise a housing adapted to imitate a defibrillator paddle and the at least one sensor may comprise a pressure sensor disposed in the housing and adapted to determine the pressure exerted by the housing on the external body.

The medical training system may further comprise a simulated torso surface having a number of magnetic targets disposed at least one of therein or thereon. The physical structure may comprise a housing and the at least one sensor of the smart peripheral device may comprise a sensing system including a plurality of hall-effect sensors disposed in or on the housing and in communication with a processor disposed within the housing. The external body may comprise a simulated torso having a number of magnetic targets disposed at least one of therein or thereon. The sensors may be positioned and adapted to detect the relative positioning of the housing with respect to at least one of the magnetic targets.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic depiction of a system for medical training in accordance with a non-limiting embodiment of the present invention;

FIG. 2 is a schematic depiction of the smart peripheral device of the system of FIG. 1;

FIG. 3 is a schematic depiction of bottom view of a portion of the smart peripheral device of FIG. 2;

FIGS. 4 and 5 are schematic illustrations of the virtual, touch-screen display portion of the training system in accordance with a non-limiting embodiment of the present invention.

FIGS. 6, 7 and 8 are schematic depictions of augmented information display provided on the virtual touch-screen display of sensor data from the smart peripherals in accordance with a non-limiting embodiment of the present invention. In this example embodiment, the sensors and display provide feedback to the learner of their applied paddle pressure.

### DESCRIPTION OF THE PREFERRED EMBODIMENTS

In the following description, for purposes of explanation, numerous specific details are set forth in order to provide a thorough understanding of the subject innovation. It may be evident, however, that the innovation can be practiced without these specific details.

While certain ways of displaying information to users are shown and described with respect to certain figures as screenshots, those skilled in the relevant art will recognize that various other alternatives can be employed. The terms “screen,” “webpage,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As employed herein, the statement that two or more parts or components are “coupled” together shall mean that the parts are joined or operate together either directly or through one or more intermediate parts or components.

As employed herein, the term “number” shall mean one or an integer greater than one (i.e., a plurality).

As employed herein, the term “smart peripheral device” or “smart peripheral” shall be used to refer to a physical peripheral device that: (1) emulates aspects of one or more components of a real medical device; (2) identifies itself to and communicates with the virtual portion of the training system; and (3) optionally includes sensing and information display capabilities that may not be present in the real device.

As employed herein, the term “hybrid simulated device” shall be used to refer to a device having a simulated virtual portion (e.g., though the use of a touchscreen device) and a portion formed from a physical member (smart peripheral) which either replicates or consists of a portion of an actual device for which the hybrid simulated device is intended to mimic.

The present invention provides improved systems and methods for training medical procedures. More particularly, the present invention provides training systems and methods that allow a student to perform procedures that very closely mimic the corresponding real procedures and also to experience real time feedback and, in certain instances, the potential negative consequences of the incorrect performance of such procedure. This enables students to better understand the consequences of their actions in real time and aids in the building of good mental models. The ability to provide feedback on performance in real-time (that is, perceptually indistinguishable from instantaneous or nearly so) also offers potential advantages to conventional medical training. For example, as will be discussed in greater detail below, in a simulation using a simulated defibrillator, incorrectly placing the paddles on the patient (e.g., location and/or pressure) can result in an ineffective discharge and may lead to other complications. By providing an immediate indication of an error and the source thereof, the trainee can immediately take corrective action. Such immediate feedback on an error in either cognitive or psychomotor performance may permit more effective self-analysis and self-correction, and an increased efficiency of skill acquisition.

In order to enhance training healthcare personnel in the operation of life-critical medical devices, embodiments of the present invention provide novel medical device simulators and methods of using which incorporate a number of novel features compared to the prior art, including, for example, without limitation, the use of “smart” peripheral devices that include sensors for aspects of trainee performance. Embodiments of the present invention provide simulations of real medical devices that both realistically emulate the real devices and also offer tutorial and performance measurement and instantaneous feedback capabilities.

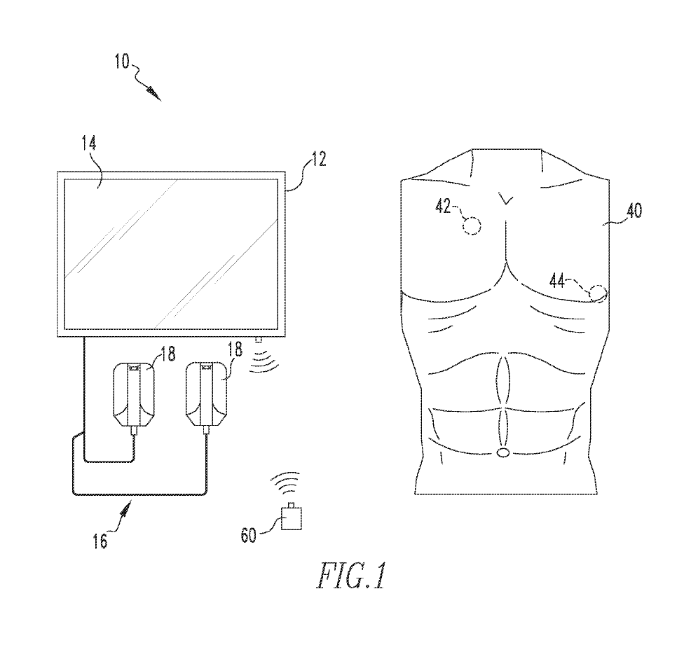

General concepts of the present invention are perhaps best illustrated by way of the following non-limiting example. Referring to FIG. 1, a schematic depiction of an example system 10 for medical training in accordance with a non-limiting embodiment of the present invention is shown. System 10 includes a processing device 12 in communication with a display 14 which may be included therewith, such as shown in FIG. 1, or provided separately therefrom (not shown). In the embodiment illustrated in FIG. 1, the processing device 12 and display 14 are provided in the form of a tablet computing device wherein display 14 is in the form of a touchscreen which functions as both an input and an output device which allows for interactions with the images displayed thereon (as will be discussed further below). It is to be appreciated, however, that other arrangements of processing devices, displays and/or input devices may be employed without varying from the scope of the present invention.

The processing device may comprise a microprocessor, a microcontroller or some other suitable processing device, that is operatively coupled to a memory. The memory can be any of a variety of types of internal and/or external storage media, such as, without limitation, RAM, ROM, EPROM(s), EEPROM(s), magnetic media, and the like, that provide a storage medium for data and software executable by the processing device for controlling the operation of other components connected thereto.

Continuing to refer to FIG. 1, system 10 further includes a smart peripheral device 16 in communication with the processing device 12. In the example embodiment illustrated in FIG. 1 the smart peripheral device is intended to replicate a pair of defibrillator paddles 18 which are in communication with the processing device 12 via a wired connection (e.g., via a USB port), it is to be appreciated, however, that other smart peripheral devices which may communicate with the processing device via any suitable wired or wireless means may be employed without varying from the scope of the present invention.

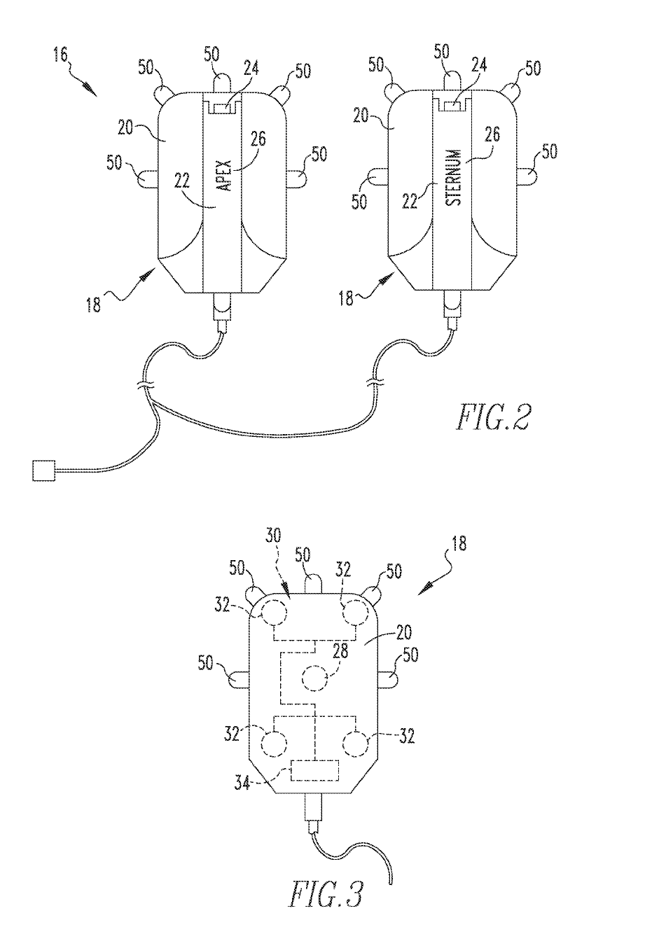

FIG. 2 shows a detailed top view of the smart peripheral device 16 from FIG. 1 and the paddles 18 thereof. Each paddle 18 includes a housing 20 adapted to replicate a paddle of an actual defibrillator device (such as actually used to resuscitate a patient) and accordingly includes a handle portion 22 and a depressible “charge” button 24 in communication with the processing device 12 such that the processing device may detect when each charge button 24 is depressed by a user and thus vary the images displayed on the display 14 in an appropriate manner. Each handle portion 22 may be provided with indicia 26 (e.g., apex, sternum) which provides an indication to a user of the location on a patient to which the paddle is to be applied.

In this example, the processing device 12 and touchscreen display 14 are used to emulate a defibrillator device. For the specific example described herein, the device emulated is a Zoll M-Series defibrillator (Zoll Medical Corporation, Chelmsford, Mass.); this specific device is modeled for illustrative purposes only, as it will be appreciated that the techniques described are not limited to a particular device, manufacturer or model. The multi-touch interface, display 14, displays a photo-realistic view of the defibrillator device's front panel. Through the use of such a touchscreen display 14, a user, using intuitive gestures (e.g., similar to those commonly used on smart phones and other similar devices), can press buttons, turn knobs, navigate menus and read displays. Additionally, the smart peripheral device 16 enables hands-on interaction by a user such that the user can actually employ the simulated device on a patient (who may be simulated, e.g., a mannequin, or portrayed by an actor, e.g., a standardized patient).

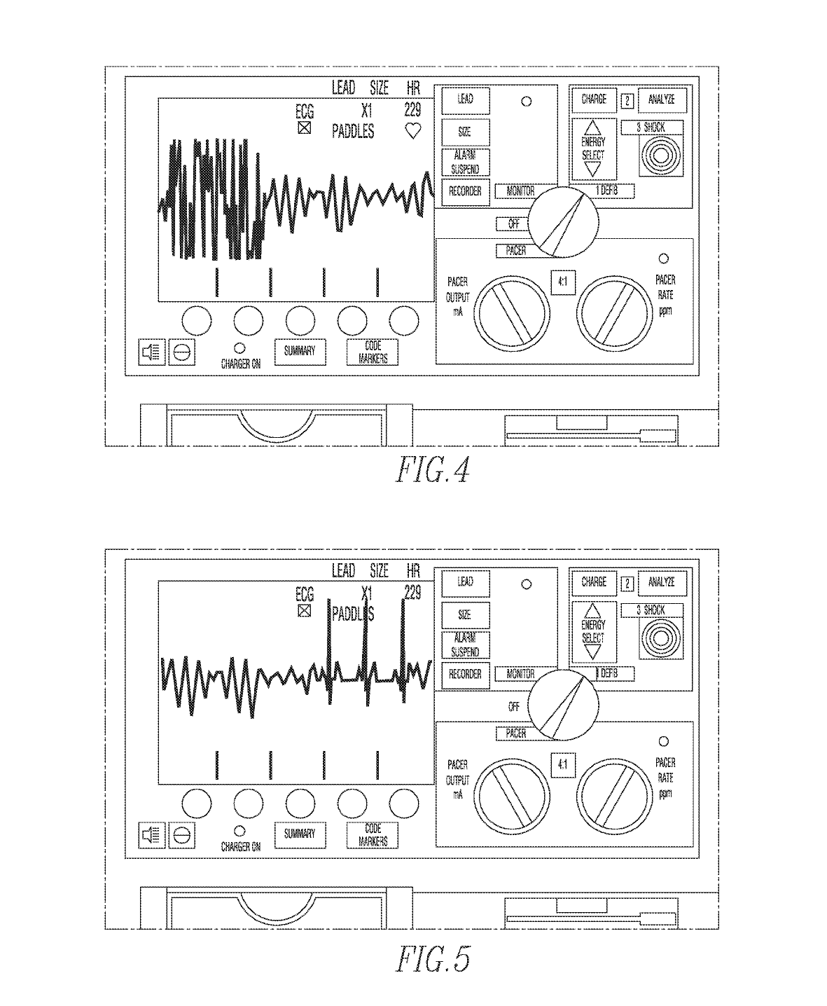

In use, when the smart peripheral device 16 is connected to the processing device 12, the processing device identifies the type of peripheral from data stored in the peripheral, for example, in a local microcontroller 34 emplaced within the peripheral. The processing device and touchscreen display then effectively “becomes” an emulator of a defibrillator by automatically executing software stored in the memory associated with the processing device 12. The user can then apply the paddles 18 to the simulated patient's chest, pressure sensors in the paddles detect contact with the chest, and a simulated ECG waveform is generated and displayed on the display 14. FIG. 4 shows a schematic example of such a display, where the waveform has changed from random noise prior to paddle contact to a simulated ventricular fibrillation waveform after paddle contact with the chest of the mannequin or standardized patient.

Through interacting with the display 14, a user of the system 10 can set the charge energy level, charge the defibrillator and administer a “shock”. However, no shock is actually delivered, so the device is safe for use by students or with standardized patients (actors used for medical training) In order to further enhance the functionality of the smart peripheral device 16, one or both of the paddles 18 may be provided with a pressure sensor 28 (FIG. 3) disposed on or within housing 20 in communication with processing device 12 such that the sensor 28 is adapted to detect the amount of pressure with which the associated paddle 18 is applied to an external body. For example, to provide adequate electrical conductivity between paddle and skin, guidelines recommend that the paddles be applied with 15-25 pounds of pressure. By monitoring such pressure, processing device 12 can compare the measured pressure with a predetermined value or range of values and provide feedback (either instantaneous or delayed) to the user in order to address improper technique.

As yet another way to enhance the functionality of the smart peripheral device 16, one or both of the paddles 18 may be provided with a sensing system 30 to detect the location of the associated paddle 18 with respect to the body on which they are placed. In the example shown in FIGS. 1-3, the sensing system 30 includes four hall-effect sensors 32 spaced within the housing 20 of each paddle (however a different number of sensors 32 may be employed) and a processor 34 (e.g., without limitation, a Teensy MCU-I/O board utilizing an Atmel ATmega32u4 microcontroller) in communication with each of the sensors 32. Such sensing system 30 is intended to be employed with a simulated body or skin having a number of “target” areas specified through the use of magnets provided on and/or embedded therein. In the example shown in FIG. 1, system 10 includes a simulated torso surface 40 having a first target region located by a first magnet 42 and a second target region located by a second magnet 44. Preferably, such magnets 42, are embedded within and or disposed behind the material from which the simulated torso surface 40 is formed such that the locations of such magnets are not detectable by a user. The simulated torso surface 40 is preferably fabricated such that it may be worn (in a manner similar to a vest) by either a mannequin or a real person.

The sensor output from sensors 32, via processor 34, may be employed in a number of different ways. The output may be communicated to the processing device 12 for recording and providing feedback, either instant or delayed, to the user. The output may also, or instead, be employed by an indication system provided directly on the smart peripheral device 16, such as shown in the example paddles 18 illustrated in FIGS. 2 and 3. In such example, the indication system is formed by a number of light emitting diodes 50 (LEDs) disposed on the housing 20 in communication (i.e., controlled by) processor 34. In the illustrated example, the LEDs 50 are disposed generally about the periphery of the housing 20. It is to be appreciated, however, that other arrangements, as well as other suitable optical indicators may be employed without varying from the scope of the present invention. The LEDs 50 may be employed to indicate to the user of a direction of movement needed to center the respective paddle 18 over the desired target (i.e., magnet 42 or magnet 44) and or to provide an indication of the paddle being cantered on the target.

For example, in an embodiment of the present invention in which multicolor LEDs are employed, respective LEDs are illuminated red to indicate to the user the direction toward the desired target. If/when it is determined that the respective paddle is centered on the desired target, one or more of the LED's are illuminated green to indicate the paddle 18 has been properly placed on the body and is ready for the charge to be supplied to the patient.

It is to be appreciated that such indication system, or a portion thereof, may also be employed with the output from pressure sensor 28 (or a separate pressure sensor) to additionally or instead provide feedback on the respective paddle 18 of the application of incorrect vs. correct applied pressure (e.g., red display=incorrect pressure, green display=correct pressure). It is also to be appreciated that one or more of the functions of such indication system on one paddle 18 may be triggered and/or delayed as a result of the placement of the other paddle 18 (e.g., the green light to discharge may be delayed until both paddles are correctly positioned).

FIG. 5 illustrates the virtual defibrillator display when a charge has been delivered by the user with correct paddle positions and contact pressure: the simulated fibrillation waveform is changed to a normal sinus rhythm ECG waveform, indicating the response of the simulated patient to correct defibrillation technique. If paddle positions or contact pressure are not correct, the simulated ECG waveform can be programmed to remain in the fibrillation state, indicating to the user that the simulated patient has not yet received correct treatment.

All of the data collected by one or both of processing device 12 and/or processor 34 may be recorded for later use, review and/or debriefing. Such data may be employed by aspects of the present invention which function in a manner similar to a “personal-trainer” by implementing built-in personal performance assessment and intelligent tutoring systems that can automatically provide learner-customized instruction, assessment and feedback. Such assessment may be provided to a user in a manner which provides for convenient, on-demand learning and skill assessment whenever and wherever needed. For example, task complexity can be modulated so a beginner has simplified tasks but a more expert user is challenged to achieve higher levels of proficiency. The “personal trainer” analogy is to a coach or trainer someone who works at a trainee's side to continually monitor and assess his/her technique, provides immediate feedback, and guides the trainee to correct performance.

Visual feedback can be provided both on the screen and on the smart peripheral devices: on-screen cues and highlighting can indicate the sequence of operations that should be performed, or visual displays such as guide-lights can be illuminated on the physical peripheral components to show a user which button should be pressed or where a component should be positioned. Audio and visual guidance can be provided to guide a user through a sequence of steps, with the automated instructor detecting at each stage whether the appropriate action has actually been performed. Just-in-time guidance can be provided based on detected user error or hesitation. For example, if a user delays operating a control more than a pre-set response time threshold, the assumption can be made that the user does not have the appropriate knowledge to proceed or is confused and additional tutorial audio/visual material can be displayed to provide more detailed information to the user on how to perform a certain task, such as positioning defibrillator paddles or ECG electrodes on the thorax, or disengaging a connector on a dialysis machine.

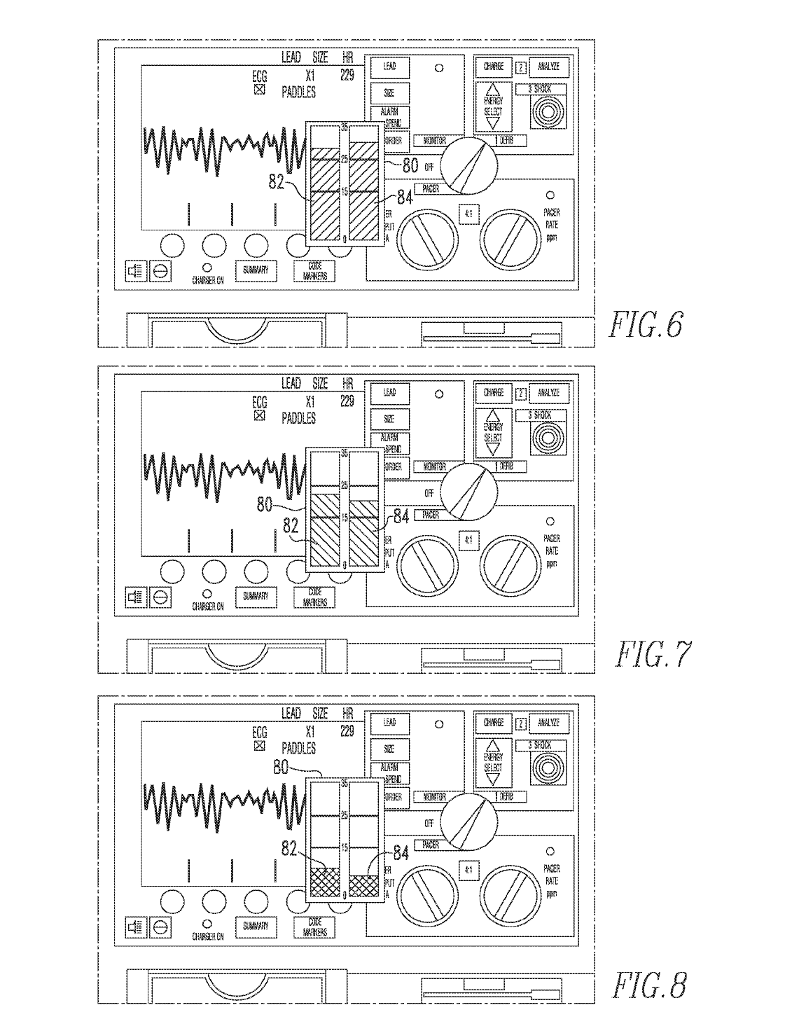

FIGS. 6, 7 and 8 illustrate an example of real-time visual feedback of applied paddle pressure. A dual bar-graph display 80 indicating left and right paddle contact force is shown displayed over the virtual front panel of the training system. FIGS. 6, 7 and 8 depict, respectively, applied contact forces over 25 lbs, force in a correct target range of 15-25 pounds, and force under 15 pounds. Such feedback, which may not be available in the actual medical device, can be turned on during initial training and help trainees learn what correct paddle pressure feels like. The feedback can then be turned off during testing or assessment, more closely emulating the procedure as performed in the actual clinical environment. As an additional indication of the pressure being applied, the color of the individual bar graphs 82 and 84 may be varied to represent the amount of applied pressure in relation to the target range. In the example embodiment illustrated in FIGS. 6-8, the bar graphs 82 and 84 are displayed in red when the pressure is above the desired range (FIG. 6), displayed in green when in the desired range (FIG. 7), and displayed in blue when below the desired range (FIG. 8).

Embodiments in accordance with the present invention provide a number of capabilities and benefits which are superior to those of the prior art.

Hybrid simulated devices such as described herein can enable low-cost usability and ergonomics testing. Compared to manufacturing a hardware prototype, a virtual prototype is much cheaper to create, test with users, and then use the test results to modify the design of the device. A new, modified design can even be downloaded to multiple test sites via network connections, obviating the need to ship physical hardware. Through the use of automated user interaction metrics, objective, quantitative data on ergonomics that can support design improvements can be monitored, analyzed and subsequently utilized. For example, through such analysis, the size and/or arrangement of elements in a physical user interface can be tested and modified accordingly using a virtual simulation on a touchscreen as it is much easier, for example, without limitation, to change the size or location of a control or provide a higher-contrast label in a software environment than in a hardware environment.

Hybrid simulated devices such as described herein are potentially very cost effective for training. For example, a single touchscreen computer with a small kit of peripherals (similar to that previously described in conjunction with FIGS. 1-8) can potentially be employed as a defibrillator trainer, ventilator trainer, and 12-lead ECG trainer during multiple training sessions in one day. Actual clinical devices do not need to be pulled from service for training Additionally, when an updated model of a device is released, the virtual version for training can simply be downloaded to the client training centers, hospitals, clinics, or other users of the system.

Hybrid simulated devices such as described herein with built-in personal trainers can deliver “anytime, anywhere” hands-on training. They can supplement (or potentially replace) in-service training sessions requiring manufacturers' personnel to travel to customers' locations.

Simulated devices with built-in performance sensing and automated assessment can also “close the loop” on training: trainees do not just run through exercises, they have to perform them correctly.

It is foreseeable that many of the training features described herein could also be built into real devices as well. For example, rather than having hundred-page device manuals (typically in several languages), a built-in device tutor could guide a user in correct operation and verify the user's proficiency in a simulated operational testing mode prior to use on a real patient.

It is to be appreciated that although the art contains several examples of screen-based emulations of medical devices (as discussed in the background) a feature of the embodiments of the present invention which distinguishes them from the prior art is the combination of sensor-enhanced physical peripheral devices (smart peripherals) with a multi-touch screen-based emulation of the device. Such arrangements enable parts of the device that are more amenable to touch-screen-based simulation (such as button presses) to be emulated in the screen-based simulation, while interactions with the device that involve more complex hands-on interactions (e.g., without limitation, applying defibrillator paddles to the chest of a patient or installing tubing in the pump section of an infusion pump) can be carried out with the physical peripheral device(s), thus enabling trainees to perform training scenarios in a realistic way. It is thus possible to partition the simulation between the virtual, screen-based world, and the physical, object-based world, to enhance and promote both cognitive and psychomotor learning.

In addition to those described herein, it is to be appreciated that other sensors or sensing systems may be employed in one or more smart peripherals in a system such as, for example, without limitation, sensors to detect if latches, doors or other parts of a device (such as an infusion pump) have been opened/closed correctly or proximity or position sensors to detect if components of a device (such as infusion tuning or a dialysis cartridge) have been installed correctly. Note that these sensors, similar to those discussed elsewhere herein, may record aspects of device operation and trainee performance that the real device itself does not sense. In this way, the simulated device provides performance assessment capabilities that go beyond those possible with the real device itself.

In addition to the interactions previously described herein, sensors may also record other aspects of interaction with the device beyond interactions with the screen or physical peripherals. For example, in an arrangement similar to that described in conjunction with FIGS. 1-5, voice recognition could detect if a user has announced “Clear!” prior to discharging the electrical energy from the defibrillator paddles. This is a crucial aspect of device operation to ensure the safety of those that are part of the care team. If “Clear!” has not been announced, the device can display the consequence of this error, as discussed in greater detail below.

As briefly discussed above, in preferred embodiments of the present invention, when the appropriate smart peripheral is connected to the computer, software previously installed on the computer enables the computer to automatically recognize the peripheral attached and launch the appropriate hybrid virtual device emulator. This makes it easy for a user to set up the system to provide complete device emulation, simply by plugging in the appropriate peripheral. Other smart peripheral devices could be plugged in and likewise automatically enable the computer to simulate the corresponding device in addition to the smart peripheral device 16 described herein. For example, plugging in a set of “smart” ECG leads could launch a 12-lead ECG monitor, or plugging in a “smart” infusion pump peripheral module could launch a complete infusion pump emulator.

The virtual device software provides the ability to record all user interactions with both the virtual devices on-screen interface elements (knobs, buttons, touch screen menu elements, etc.) and all interface elements on the physical peripheral devices (buttons, dials, etc.) and all sensor data from the sensors built into the physical peripheral devices. For example, in the virtual defibrillator example described herein, changes of state of all screen-based virtual controls, all defibrillator paddle controls, and paddle pressure sensor data are recorded at a resolution of 1/100 sec.

This rich set of performance data acquired can be utilized for several benefits. The data can be mined and analyzed by algorithms such as clustering algorithms to determine “signatures” of novice and expert performance. For example, the patterns of user-device interactions and errors among novices and experts can be analyzed to discover which data features have maximum predictive power to differentiate the two groups of users. Educational data mining methods, including cluster analysis, can develop models of the behavior characteristics of experts and novices while using the virtualized device. These models will estimate a learner's degree of expertise, using information about the speed, accuracy, and nature of the user's actions. Such data can also be utilized to define a distance metric between novice and expert performance (e.g., the Euclidean distance between the centroids of the novice and expert clusters in the n-dimensional space of interaction parameters). This metric can be used to provide customized, learner-adaptive tutorial feedback and instruction, and also serve as an empirically-based assessment of whether a user has attained a desired level of proficiently in device operation before being allowed to use the real device on a real patient.

Hybrid simulated devices as described herein can display other information besides the front-panel of the simulated device. For example, a “consequence display” (i.e., the dramatic visualization of the consequences of a user's operation of the device) may be provided. For example, suppose that a user has not announced “Clear!” prior to discharging the defibrillator energy. Such lack of warning can pose a risk to those near the patient (e.g., if a medical student is touching the metal railing of the patient's bed, it is possible for him or her to receive a jolt of energy from the discharge). If such error is detected (e.g., through use of a microphone in communication with the processor), the screen of the hybrid simulated device can then change from a simulated view of the simulated device's front panel to a video showing the trainee's point of view in a patient's room as a nurse looks at the trainee and shouts “What did you do?” as the camera pulls back to show a medical student lying on the floor next to the patient bed. The trainee now has to deal with two patients, instead of one, and has been dramatically (and hopefully memorably) shown the consequences of his/her error. Such ability to make mistakes and immediately see the consequences thereof helps to promote acquisition and retention of correct behaviors.

Hybrid simulated devices as described herein can provide automatically generated remote signaling of user performance data to instructors, assistants or other participants in the simulation scenario. Such signaling may be provided remotely though a device in communication (either wired or wirelessly) with the processing device of the hybrid simulated device, such as, for example without limitation, the receiver device 60 shown schematically in FIG. 1. Receiver device 60 a small, wireless-enabled, battery-powered vibrotactile device with a cell-phone vibrator motor inside in RF communication with processing device 12 (as shown by dashed line). Suppose a trainee is using the virtual medical device in a scenario in which a standardized patient (actor) has collapsed to the floor due to a cardiac event. The actor has the device 60 in his/her pocket. Various signals can now be communicated to the “patient”, even if his/her eyes are closed. For example, suppose the trainee does not perform the defibrillation procedure correctly (e.g., he does not press the paddles to the patient's chest with the required degree of force (15-25 lbs, nominally, according to national guidelines)). At the moment the defibrillator energy is discharged, a “one-buzz” signal is sent to the vibrotactile device. Such signal indicates to the actor that the actor should “twitch”, creating a realistic response to defibrillation, but not awaken, because even though energy was “virtually” applied, insufficient pressure resulted in poor paddle contact with the skin and not enough energy was delivered to restore the heart to its normal rhythm. Now the trainee applies the paddles with correct pressure and executes all other steps correctly. When the shock is delivered, a “three-buzz” sequence (for example, without limitation) can be sent to the buzz box. This signals the actor to twitch, then wake up (regain consciousness), as the procedure has now been performed correctly.

The wireless vibrotactile signaling can be used in a wide variety of other ways to enable instructors and others in a simulation scenario to be aware of whether a device is being operated according to pre-established criteria. This enables enhanced communication and realism of reaction and response.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A smart peripheral device for use in a medical training system having a processing device, software to emulate aspects of a medical device and a display in communication therewith, the processing device, software and display providing an interactive interface which emulates a portion of a medical device, the smart peripheral device comprising:
a physical structure adapted to imitate a functional component of a medical device; and
at least one sensor adapted to measure an aspect of the physical structure, the aspect being one or more of position with regard to an external body, pressure exerted on the external body, or other physical variable.

2. The smart peripheral device of claim 1 wherein the functional component of the medical device which the physical structure is adapted to imitate comprises a housing adapted to imitate a defibrillator paddle.

3. The smart peripheral device of claim 2 wherein the at least one sensor comprises a pressure sensor adapted to determine the pressure exerted by the housing on the external body.

4. The smart peripheral device of claim 1 wherein the at least one sensor comprises a sensing system adapted to detect the relative position of the physical structure of the peripheral device with respect to the external body.

5. The smart peripheral device of claim 4 wherein:
the physical structure comprises a housing;
the sensing system includes a plurality of hall-effect sensors disposed in or on the housing and in communication with a processor disposed within the housing,
the external body comprises a simulated torso surface having a number of magnetic targets disposed at least one of therein or thereon, and
the sensors are positioned and adapted to detect the relative positioning of the housing with respect to at least one of the magnetic targets.

6. The smart peripheral device of claim 1 wherein the physical structure further includes a number of optical indicators disposed thereon.

7. The smart peripheral device of claim 6 wherein the number of optical indicators comprise a plurality of light emitting diodes.

8. The smart peripheral device of claim 7 wherein the plurality of light emitting diodes are adapted to provide an indication to a user of the smart peripheral device of the relative positioning of a target on the external body with respect to the physical structure.

9. The smart peripheral device of claim 8 wherein the indication comprises:
illuminating at least one light emitting diode of the plurality of light emitting diodes a first color as an indication the physical structure is not positioned on the target; and
illuminating at least two of the light emitting diodes a second color as an indication the physical structure is positioned on the target.

10. A medical training system, the system comprising:
a processing device;
software to emulate aspects of a medical device;
a display in communication with the processing device; and
a smart peripheral device as recited in claim 1,
wherein the at least one sensor is in communication with the processing device.

11. The medical training system of claim 10 wherein the processing device is adapted to automatically identify the smart peripheral device is connected to the processing device and wherein the processing device is adapted to then automatically execute software to simulate the medical device that corresponds to the peripheral.

12. The medical training system of claim 10 further comprising a wireless vibrotactile signaling device that enables vibratory signals to be displayed corresponding to various states of the system, including the states wherein a user's performance has been sensed as either correctly or incorrectly executing a task.

13. The medical training system of claim 10 wherein the physical structure of the smart peripheral device comprises a housing adapted to imitate a defibrillator paddle and wherein the at least one sensor comprises a pressure sensor disposed in the housing and adapted to determine the pressure exerted by the housing on the external body.

14. The medical training system of claim 10, further comprising a simulated torso surface having a number of magnetic targets disposed at least one of therein or thereon and wherein:
the physical structure comprises a housing,
the at least one sensor of the smart peripheral device comprises a sensing system including a plurality of hall-effect sensors disposed in or on the housing and in communication with a processor disposed within the housing,
the external body comprises a simulated torso having a number of magnetic targets disposed at least one of therein or thereon, and
the sensors are positioned and adapted to detect the relative positioning of the housing with respect to at least one of the magnetic targets.
